(19) United States
(12) Patent Application Publication
(10) Pub. No.: US 2025/0362427 A1
(43) Pub. Date: Nov. 27, 2025

(54) METHOD AND SYSTEMS FOR CALCULATING THE BLANKETING EFFECT IN MODELING OIL SYSTEMS AND COMPUTER-READABLE STORAGE MEDIA

(71) Applicants: PETRÓLEO BRASILEIRO S.A. – PETROBRAS, Rio de Janeiro (BR); UNIVERSIDADE FEDERAL DO RIO DE JANEIRO – UFRJ, Rio de Janeiro (BR)

(72) Inventors: Ivan Soares LOUTFI, Rio de Janeiro (BR); Cleriston Ferreira SILVA, Rio de Janeiro (BR); Jaci Maria Bernardo Da Silva GUIGON, Rio de Janeiro (BR); Hugo Bastos De Sá BRUNO, RJ (BR)

(21) Appl. No.: 19/196,890

(22) Filed: May 2, 2025

(30) Foreign Application Priority Data
May 24, 2024 (BR) 1020240103882

(51) Int. Cl. G01V 20/00; G06F 30/23; G06F 30/28; G06F 113/08

(52) U.S. Cl. CPC G01V 20/00; G06F 30/23; G06F 30/28; G06F 2113/08

(57) ABSTRACT

The present disclosure relates to methods and systems for calculating the blanketing effect in modeling oil systems. An embodiment of a method includes obtaining input lithospheric and sedimentary data, discretizing the model differently in the sedimentary domain and in the lithospheric domain, starting the calculation of the blanketing effect, checking whether the deposition time corresponding to each sedimentary layer is greater than the present time and whether the age of the basin is greater than the deposition time corresponding to each sedimentary layer, refraining from performing, and checking whether the deposition time corresponding to each sedimentary layer is less than or equal to the present time and whether the age of the basin is less than or equal to the deposition time corresponding to each sedimentary layer.

### FIELD OF THE DISCLOSURE

The present disclosure pertains to the technical field of modeling oil systems. In particular, the present disclosure relates to a method for calculating the blanketing effect in modeling oil systems and computer-readable storage media.

### BACKGROUNDS OF THE DISCLOSURE

In the study of sedimentary basins and oil systems, with the aim of better assessing geological risks in the exploration of new areas, it is increasingly necessary to obtain more accurate predictive results of temperature and heat flow. Such predictive results allow the analysis of new potential areas, especially in distal regions, where data obtained from wells become increasingly scarce.

In order to obtain more accurate predictive results for temperature and heat flow, geological process simulations are usually performed, where backstripping is calculated, which is the removal of sedimentary layers and their decompaction for each geological event, obtaining paleogeometry estimates during the geological evolution of the sedimentary section.

Typically, 3D oil systems analysis software calculates backstripping using multi-1D equations, considering geological basins under the effect of local isostasy. In other software applications, the implemented model calculates backstripping in a more refined way, coupling flexural isostasy effects in the 3D basin and, therefore, approaching the conditions observed in nature due to flexural effects of the lithospheric layer. The flexural response allows for a more precise determination of the paleogeometries of the basement and sedimentary layers and is directly linked to the thermal state of the lithosphere, which, in turn, controls the heat flow in the basement of the sedimentary basin at each time step.

To determine the heat flow to be used as a lower boundary condition in simulations inside the sedimentary basin, it is necessary to quantify the thermal evolution resulting from the geothermal gradient, lithospheric stretching (rifting) and radiogenic heat present in the upper portion of the crust.

However, the transient thermal effect related to the deposition and compaction of cold sediments, known as the blanketing effect, is currently not measured, which blanketing effect can act during and after sedimentation, causing alterations such as: reduction of the geothermal gradient of the crust and, consequently, reduction of the heat flow in the basement and heating at the end of each deposition phase by the transient heat diffusion process, for the thermal rebalancing of the temperature field of the lithosphere, which depend on the thermal conductivity, thickness and sedimentation rate of the sedimentary package.

### State of the Art

The document entitled “Impacto do efeito blanketing na história térmica de bacias sedimentares: modelos sintéticos e estudo de caso na Bacia de Santos” (Impact of the blanketing effect on the thermal history of sedimentary basins: synthetic models and case study in the Santos Basin), by Cleriston Ferreira Silva (accessible at https://pantheon.ufrj.br/handle/11422/13673?mode=full) discloses an extensive study on the effect of the deposition of cold sediments (blanketing) on heat flows at the top of the basement, considering or not the effect of rifting (lithospheric thinning). Specifically, this document only describes specific tests and one-dimensional (1D) scope for the blanketing effect.

The document “Thermal evolution of the intracratonic Paris Basin: insights from 3D basin modelling” by Martina Torelli, Renaud Traby, Vanessa Teles and Mathieu Ducros (available at https://www.sciencedirect.com/science/article/abs/pii/S0264 817220302701?via % 3Dihub) encompasses a 3D model of a basin, identifying parameters that affect the temperature distribution over time, showing the temporal evolution of sedimentary basins. However, this document does not disclose the application of the blanketing effect.

### BRIEF DESCRIPTION OF THE DISCLOSURE

The present disclosure, according to a preferred embodiment thereof, defines a method for calculating the blanketing effect in the modeling of oil systems comprising:
obtaining input lithospheric and sedimentary data;
discretizing the model differently in the sedimentary domain and in the lithospheric domain;
starting the calculation of the blanketing effect;
checking whether the deposition time corresponding to each sedimentary layer is greater than the present time and whether the age of the basin is greater than the deposition time corresponding to each sedimentary layer, refraining from carrying out the method;
checking whether the deposition time corresponding to each sedimentary layer is less than or equal to the present time and whether the age of the basin is less than or equal to the deposition time corresponding to each sedimentary layer and checking whether it is in the rifting period, wherein:
if it is in the rifting period, calculating the rifting;
if it is not in the rifting period or if it is following the step of calculating the rifting, calculating sedimentation;
calculating the advective vertical displacement velocity due to the rifting for each XY coordinate;
calculating fluid flow;
using finite elements to perform the calculation at each instant in time;
performing the sum of the thermal effect of the lithospheric and sedimentary domains at each time step.

Specifically, according to another preferred embodiment of the present disclosure, the lithospheric and sedimentary data comprise at least one of:
area dimensions;
thermophysical parameters, such as: Crust conductivity (W/m/K); Crust specific mass (kg/m³); Crust specific heat (J/kg/K); Crust radiogenic heat (μW/m³); Lithospheric mantle conductivity (W/m/K); Lithospheric mantle specific mass (kg/m³); Lithospheric mantle specific heat (J/kg/K); Lithospheric mantle radiogenic heat (μW/m³); Water specific mass (kg/m³); Water conductivity (W/m/K); Water specific heat (J/kg/K); Asthenosphere specific mass (kg/m³); Coefficient of elasticity (N/m²); Poisson's ratio; Coefficient of thermal expansion (1/° C.); Acceleration of gravity (m/s²);
boundary conditions in the lithosphere, such as surface temperature and base temperature;
lithospheric data, corresponding to the number of layers and thermophysical properties of the layer, comprising at least one of: Thickness (m); Specific mass (kg/m³); Specific heat (J/kg/K); Conductivity (W/m/K); Radiogenic heat (W/m³*1e-6);
horizon and lithofacies maps for each sedimentary layer; wherein salt and igneous maps are optional, depending on the region of interest;
values for the discretization of the numerical model, wherein the values can be defined by the user, in the “number of steps” or “spacing” column, for temporal discretization; and in the columns “number of elements” or “Spacing”, for spatial discretization in the x, y and z dimensions. Greater discretization is suggested: 1) in the rift period (thousands of years) and 2) in the sedimentary part (tens or hundreds of meters in thickness in z, corresponding to the maximum depth of the basin); for the other periods and areas, a discretization between 2-3 thousand meters will guarantee convergence and good results);
age of the basin (in millions of years—mya.);
time and period of the rift (in millions of years—mya.);
values or maps of the stretching factors of the lithosphere (β) or crust and mantle (δ and β).

Additionally, according to another preferred embodiment of the present disclosure, the step of calculating the rifting if in the rifting period comprises calculating the transient heat due to lithospheric thinning, which causes variations in the heat flow, from the advective thermal model:

$${( ρ c ) ( θ ) \frac{\partial T}{\partial t} + ( 1 - θ ) {( ρ c )}_{s} {T}_{, i} {v}_{i}^{s} = λ ( θ ) {T}_{, i} )}_{, i} + ( ρ r ) ( θ ) ∀ x ∈ Ω$$

where:
v^{s} denotes the velocity of the solid particles;
θ is the porosity;
ρ is the specific mass;
c is the decay constant;
and λ is the conductivity;
   calculating the crust value o and the mantle value β within the rift, according to:

$$β = {e}^{G Δ t}$$

calculating thicknesses and horizons of the sediment layers as a function of the crust value δ and the mantle value β;
   quantifying the radiogenic heat in the upper portion of the crust.

Furthermore, according to another preferred embodiment of the present disclosure, the step of calculating sedimentation includes calculating the blanketing effect due to sediment deposition, through an advective model, including:
decompacting sediment layers (backstripping);
stacking and compacting sediment layers up to the corresponding deposition time and according to the thermal parameters recalculated in depth;
recalculating basement depth;
calculating the radiogenic heat in the sedimentary portion.

Additionally, according to another preferred embodiment of the present disclosure, the step of calculating the advective vertical displacement velocity due to rifting for each xy coordinate corresponds to calculating vbulk=G*(h−z) for each z coordinate, where vbulk=average velocity of the asthenosphere uplift due to rifting, varying linearly in z; G=magnitude of the vertical velocity gradient along the lithosphere h, indicating how much the fluid velocity (asthenosphere) displaces vertically, along the thickness defined as “h” in the formulation; h=limit of the depth of the lithosphere. Once this calculation has been performed, there is performed the addition of the advective velocities to the sedimentation velocity, wherein the greater the compaction, the slower the uplift due to rifting.

Additionally, according to another preferred embodiment of the present disclosure, the step of calculating fluid flow includes defining thermal properties in the nodes of the 3D numerical grid, comprising at least one of conductivity, radiogenic heat, specific mass*specific heat of the solid part (hc_bulk), specific mass*specific heat of the fluid part (hc_water).

Furthermore, the method of the present disclosure additionally comprises the step of generating outputs for the corresponding deposition time, including generating maps, sections and well profiles with the thermal and structural information of the sedimentary basin.

Further, according to another preferred embodiment of the present disclosure, a computer-readable storage media is defined comprising, stored therein, a set of computer-readable instructions, which when executed by a computer, executes the method for calculating the blanketing effect in modeling oil systems of the present disclosure.

### BRIEF DESCRIPTION OF THE FIGURES

In order to complement the present description and to obtain a better understanding of the features of the present disclosure, and according to a preferred embodiment thereof, a set of figures is presented in attachment, where in an exemplary, although not limitative, manner its preferred embodiment is represented.

FIG. 1 illustrates a flowchart of an embodiment of a method for calculating the blanketing effect in modeling oil systems.

FIG. 2 shows a flowchart of the numerical solution process of an embodiment of a method of the present disclosure.

FIG. 3 illustrates a Screen of an application for inputting the dimensions of the area under study, thermophysical parameters and thermal boundary conditions, according to an embodiment of the present disclosure.

FIG. 4 shows an interface of an application for inputting the characteristics of the lithosphere, number of layers and thermophysical properties, according to an embodiment of the present disclosure.

FIG. 5 shows a screen of an application for inputting maps, lithofacies, salt and igneous layers, the definition of the lithofacies library is illustrated, according to an embodiment of the present disclosure.

FIG. 6 shows a screen of an application for inputting values for discretization of the numerical model, basin age and time, rift period, values or maps of the stretching factors of the lithosphere, or crust and mantle, according to an embodiment of the present disclosure.

FIG. 7 presents examples of maps used as

data input, according to an embodiment of the present disclosure.

FIG. 8 represents the domain for a simplified 1D model, according to an embodiment of the present disclosure.

FIG. 9 is a schematic drawing of the lithospheric rifting process, according to an embodiment of the present disclosure.

FIG. 10 shows the schematic model for updating the properties in the nodes of the finite element mesh, according to an embodiment of the present disclosure.

FIG. 11 illustrates the partitioning of the finite element mesh, according to an embodiment of the present disclosure.

FIG. 12a shows heat flow maps for all sedimentary deposition times, according to an embodiment of the present disclosure.

FIG. 12b illustrates maps of effective elastic thickness, according to an embodiment of the present disclosure.

FIG. 12c presents paleogeometries of the basement and sedimentary layers, according to an embodiment of the present disclosure.

FIG. 12d shows a graph with heat flow results, according to an embodiment of the present disclosure.

FIG. 13a shows a graph that illustrates the coupling of the blanketing effect, when the effect of the sedimentation rate and the sedimentary deposition process are considered, according to an embodiment of the present disclosure.

FIG. 13b presents a graph that shows a basin scenario with sediments (lithofacies map) and rifting (beta map), according to an embodiment of the present disclosure.

FIG. 13c presents a graph that shows a basin scenario without sediments, according to an embodiment of the present disclosure.

FIG. 13d illustrates a graph of a scenario where the sediment conductivity is equal to 2.5 W/m/K and the crust conductivity is equal to 2.5 W/m/K, according to an embodiment of the present disclosure.

FIG. 13e illustrates a graph of a scenario where the sediment conductivity is equal to 1.25 W/m/K and the crust conductivity is equal to 2.5 W/m/K, according to an embodiment of the present disclosure.

FIG. 13f illustrates a graph of a scenario where the sediment conductivity is equal to 5 W/m/K and the crust conductivity is equal to 2 W/m/K, according to an embodiment of the present disclosure.

### DETAILED DESCRIPTION OF THE DISCLOSURE

FIG. 1 illustrates a flowchart of the method for calculating the blanketing effect in modeling oil systems, according to an embodiment of the present disclosure, and its respective description presented below elucidates the steps and calculations involved in the 3D simulation of thermal and structural processes in sedimentary basins, taking into account the implementation of the blanketing effect, which will significantly influence the thermal evolution of the analyzed areas, over geological time.

The method for calculating the blanketing effect in modeling oil systems involves coupling thermal events of sedimentary and lithospheric origin, generating refined results of temperatures, heat flow and paleogeometries of sedimentary basins in the form of 3D maps. The method comprises the inclusion of the effect of sediment deposition in the thermal results of basins, through coupling between the lithospheric and sedimentary portions in the computational thermal model, improving the accuracy of the results when compared with well data, especially those related to temperature and vitrinite.

The results obtained through the method of the present disclosure can be used as thermal and structural boundary conditions for integration with other oil systems modeling software and also for direct thermal calibration, by comparing the results obtained from the model with well data from a region or basin under study.

In particular, the blanketing effect is resolved within the time loop, combining the lithospheric and sedimentary effects, respectively. In particular, the method calculates: a) thermal diffusion processes; b) advection effects due to lithosphere rifting; c) advection effects due to sediment deposition (blanketing effect); d) radiogenic heat generation.

The method for calculating the blanketing effect in modeling oil systems comprises the following steps:
obtaining input lithospheric and sedimentary data 1, wherein the lithospheric and sedimentary data comprise at least one of:
   area dimensions;
   thermophysical parameters, such as: Crust conductivity (W/m/K); Crust specific mass (kg/m³); Crust specific heat (J/kg/K); Crust radiogenic heat (μW/m³); Lithospheric mantle conductivity (W/m/K); Lithospheric mantle specific mass (kg/m³); Specific heat of the lithospheric mantle (J/kg/K); Radiogenic heat of the lithospheric mantle (μW/m³); Specific mass of water (kg/m³); Conductivity of water (W/m/K); Specific heat of water (J/kg/K); Specific mass of the asthenosphere (kg/m³); Coefficient of elasticity (N/m²); Poisson's ratio; Coefficient of thermal expansion (1/° C.); Acceleration of gravity (m/s²); Isotherm temperature for Te (° C.);
   boundary conditions in the lithosphere, such as surface temperature and base temperature;
   lithospheric data, corresponding to the number of layers and thermophysical properties of the layer, comprising at least one of: Thickness (m); Specific mass (kg/m³); Specific heat (J/kg/K); Conductivity (W/m/K); Radiogenic Heat (μW/m³);
   maps of horizons and lithofacies for each sedimentary layer; wherein salt and igneous maps are optional, depending on the region of interest;
   values for discretization of the numerical model, wherein the values can be freely defined by the user in the “number of steps” or “spacing” column, for temporal discretization; and in the “number of elements” or “Spacing” columns, for spatial discretization in the x, y and Z dimensions (as illustrated in FIG. 6). Greater discretization is suggested: 1) in the rift period (thousands of years) and 2) in the sedimentary part (tens or hundreds of meters in the thickness in z corresponding to the maximum depth of the basin); for the other periods and areas, a discretization between 2-3 thousand meters will guarantee convergence and good results);
   age of the basin (in millions of years—mya);
   time and period of the rift (in millions of years—mya);
   values or maps of the stretching factors of the lithosphere (β) or crust and mantle (δ and β);
discretizing the numerical model, including discretizing the model differently in the sedimentary domain and in the lithospheric domain 2;
starting calculating the blanketing effect 3;
checking whether the deposition time corresponding to each sedimentary layer t is greater than the present time and whether the age of the basin is greater than the deposition time corresponding to each sedimentary layer t 4 and refraining from performing method 5;
checking whether the deposition time corresponding to each sedimentary layer t is less than or equal to the present time and whether the age of the basin is less than or equal to the deposition time corresponding to each sedimentary layer t 4 and checking whether it is in the rifting period 6, wherein:
if it is in the rifting period, calculating the rifting period 7, including calculating the transient heat due to lithospheric thinning, which causes variations in the heat flow, from the advective thermal model:

$$( ( ρ c ) ( θ ) \frac{\partial T}{\partial t} + ( 1 - θ ) {( ρ c )}_{s} {T}_{, i} {v}_{i}^{s} = λ ( θ ) {( {T}_{, i} )}_{, i} + ( ρ r ) ( θ ) ∀ x ∈ Ω \qquad ( Equation 1 )$$

where:
v^{s} denotes the velocity of the solid particles;
θ is the porosity;
ρ is the specific mass;
c is the decay constant;
and λ is the conductivity;
   calculating the crust value δ and the mantle value β within the rift, according to Equation 2:

$$β = {e}^{G Δ t} \qquad ( Equation 2 )$$

calculating thicknesses and horizons of the sediment layers as a function of the crust value δ and the mantle value β;
   quantifying the radiogenic heat in the upper portion of the crust.
if it is not in the rifting period or if it is following the rifting calculation step 7, calculating sedimentation 8, including calculating the blanketing effect due to sediment deposition, through an advective model, including:
   decompacting sediment layers (backstripping);
   stacking and compacting sediment layers until the corresponding deposition time and according to the thermal parameters recalculated in depth;
   recalculating basement depth;
   calculating radiogenic heat in the sedimentary portion;
   calculating advective vertical displacement velocity due to rifting 9, for each xy coordinate, by using the formulation vbulk=G*(h−z) for each z coordinate, where vbulk=average velocity of asthenosphere uplift due to rifting, varying linearly in z; G=magnitude of the vertical velocity gradient along the lithosphere h, indicating how much the fluid velocity (asthenosphere) displaces vertically, along the thickness defined as “h” in the formulation; h=depth limit of the lithosphere. Once this calculation is performed, the advective velocities are added to the sedimentation velocity, wherein the greater the compaction, the slower the uplift due to rifting;
   calculating fluid flow 10, including defining thermal properties in the nodes of the 3D numerical grid, including conductivity, radiogenic heat, specific mass*specific heat of the solid part (hc_bulk), specific mass*specific heat of the fluid part (hc_water)
   using finite elements to perform calculations at a given time 11;
   performing the sum of the thermal effect of the lithospheric and sedimentary domains at each time step 12;
   generating outputs for the corresponding deposition time 13, including generating maps, sections and well profiles with thermal and structural information of the sedimentary basin;
   In particular, the step of using finite elements to perform calculations at a given time 11 includes using the PCG Method—Solver Default Tolerance: 1.e-07 and distributed processing, using OpenMP directly in the code.

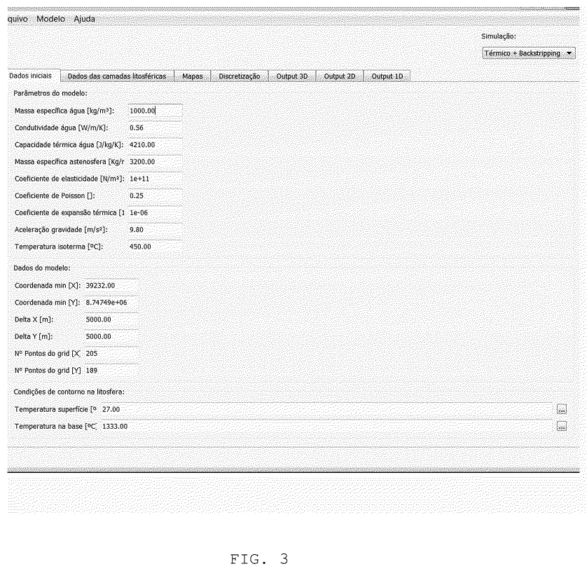

FIG. 3 illustrates a screen of an application that implements the method of the present disclosure for inputting the dimensions of the area under study, thermophysical parameters and thermal boundary conditions.

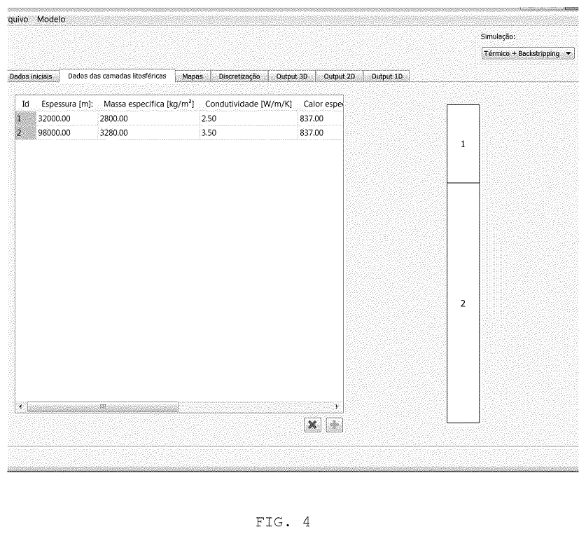

FIG. 4 shows an interface of an application that implements the method of the present disclosure for inputting the characteristics of the lithosphere, number of layers and thermophysical properties.

FIG. 5 shows a screen of an application that implements the method of the present disclosure for inputting maps, lithofacies, salt and igneous layers; the definition of the lithofacies library is illustrated.

FIG. 6 shows a screen of an application that implements the method of the present disclosure for inputting values for discretization of the numerical model, basin age and time, rift period, values or maps of the stretching factors of the lithosphere (β) or crust and mantle (δ and β).

The lithofacies library is created to define the lithologies distributed in each sedimentary layer. The library includes an ID-used to identify the lithofacies in the horizon maps-and corresponding properties, associated with the ID, as indicated in Table 1:

TABLE 1
Properties for the lithologies that
will compose each sedimentary layer

| | |
|---|---|
| Specific mass | kg/m³ |
| Surface porosity | % |
| Compaction coefficient | 1/m |
| Diffusivity | m²/s |
| Conductivity | W/m/K |
| Radiogenic heat | μW/m³ |

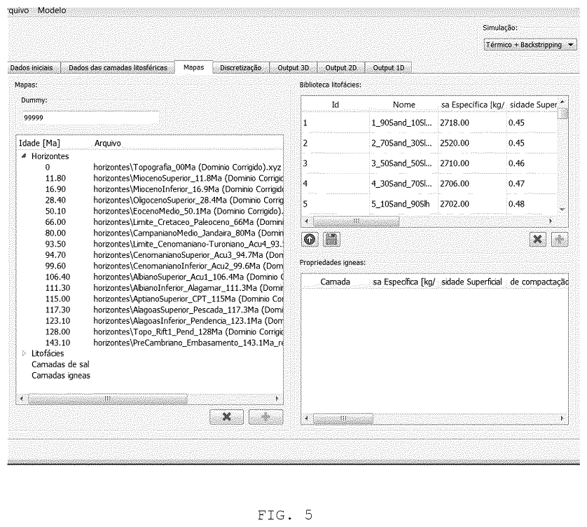

As for the maps, a plurality of maps can be used data input: horizons, lithofacies, boundary conditions, salt thickness, stretching factors, properties, among others. The maps are provided in the form of files, normally in the .xyz format (x-coord., y-coord., z-value). FIG. 7 presents examples of maps used as data input in the method of the present disclosure.

More specifically, what characterizes the blanketing effect or blanketing effect is the implementation where the parameters of equation 1, θ, ρ, c and λ (porosity, specific mass, decay constant and conductivity, respectively) vary based on the porosity/depth relation of the sedimentary matrix.

According to Athy's Law (from Athy L. F., 1930, “Density, porosity, and compaction of sedimentary rocks”, AAPG Bulletin, v. 14, n. 1, pp. 1-24), the variation of porosity θ according to depth z is given by equation 3 below:

$$θ ( z ) = {θ}_{0} exp ( \frac{- z}{c} ) , \qquad ( Equation 3 )$$

where θ₀ is the surface porosity and c is the compaction coefficient of the sedimentary matrix.

With this, the other parameters of equation 1 will vary according to the porosity/depth values given as a function of variable 0.

The effective conductivity of the sedimentary matrix is obtained from the geometric mean between the conductivity of the solid phase λ_s and the conductivity of the water that fills the porous part, λ_w, in other words:

$$λ ( θ ) = {λ}_{s}^{( 1 - θ )} {λ}_{w}^{θ} . \qquad ( Equation 4 )$$

The effective specific heat (ρc) is obtained by the weighted average between the solid part (ρc)ₛ and the fluid part (ρc)_{w}, that is:

$$( ρ c ) ( θ ) = ( 1 - θ ) {( ρ c )}_{s} + {θ ( ρ c )}_{w} . \qquad ( Equation 5 )$$

The effective radiogenic heat (ρr) is obtained only by weighting the solid part, that is:

$$( ρ r ) ( θ ) = ( 1 - θ ) {( ρ r )}_{s} . \qquad ( Equation 6 )$$

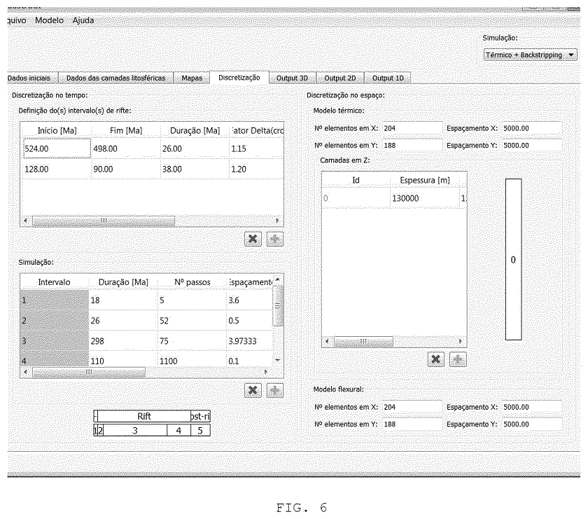

Furthermore, the advective velocities of the solid part and the fluid part corresponding to the sediments are obtained from the law of conservation of mass applied to the sedimentary layers. The formulation for the 1D case with only one sedimentary layer is developed for a domain, according to FIG. 8, which is the representation of the domain for a simplified 1D model, taken and adapted to the Portuguese language, from Hutchison, I., 1985; The effects of sedimentation and compaction on oceanic heat flow, Geophysical Journal of the Royal Astronomical Society 82 (3) 439{459. doi:10.1111/j.1365-246X.1985.tb05145.x.3.

The deposition velocity at z=0 is:

$${v}_{s} = \frac{{v}_{0} ( 1 - {θ}_{0} )}{( 1 - θ )} . \qquad ( Equation 7 )$$

Additionally, the velocity of basement movement at z=B is:

$${v}_{b} ( t ) = \frac{{v}_{0} ( 1 - {θ}_{0} )}{( 1 - θ ( B ) )} . \qquad ( Equation 8 )$$

Then, the velocity of basement movement for any t, any z, will be given by:

$${v}_{w} ( z , t ) = \frac{{v}_{0} ( 1 - {θ}_{0} )}{( 1 - θ ( B ) )} {e}^{( \frac{z - B}{ξ} )} . \qquad ( Equation 9 )$$

The complete methodology is given by adding the effect of the sedimentary deposition, blanketing effect, to the rifting processes in the lithosphere and radiogenic heat, in the lithospheric and sedimentary domains, which are inserted into the heat diffusion/advection equation in a 3D solid medium (equation 1).

Rifting is the process of narrowing/thinning

of the lithosphere and displacement of asthenosphere material in the vertical direction, as shown in FIG. 9. FIG. 9 schematically represents the process of lithospheric rifting. On the left, the lithosphere is in normal configuration. On the right, the lithosphere is thinned by a parameter β and there is a consequent uplift of asthenospheric material.

In this way, the asthenosphere is uplifted, from the depth limit z(x, y)=0, in order to fill the space left by the exit of lithospheric material due to its thinning and is represented in the advective term of equation 1, together with the process of sedimentary deposition (vertical velocity).

The blanketing effect of sediments and advection due to rifting are vertically competing processes, so that the greater the compaction, the slower the uplift velocity due to lithospheric thinning.

### 3D Numerical Solution of the Transient Heat Transport Problem in Finite Elements

The numerical solution of the methodology presented for quantifying the blanketing effect coupled with other thermal processes was developed in Finite Elements. The solution for the three-dimensional case is made by evaluating the compaction independently at each node of the finite element mesh.

The numerical model uses hexahedral elements H8, with 8 nodes for the solution in the x-y direction and elements with 12 nodes H12, in the z direction.

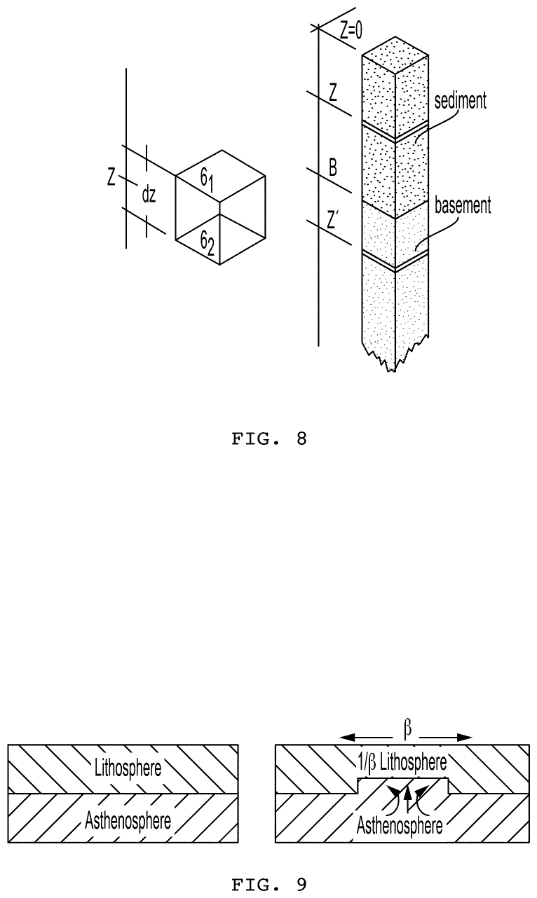

The deposition of sediments and rifting cause changes in the geological properties of each finite element over time, that is, the elements of the mesh are subject to changes in the geological properties of their domains (FIG. 11).

In the implementation, it is assumed that the properties are interpolated through the same shape functions of the element in question.

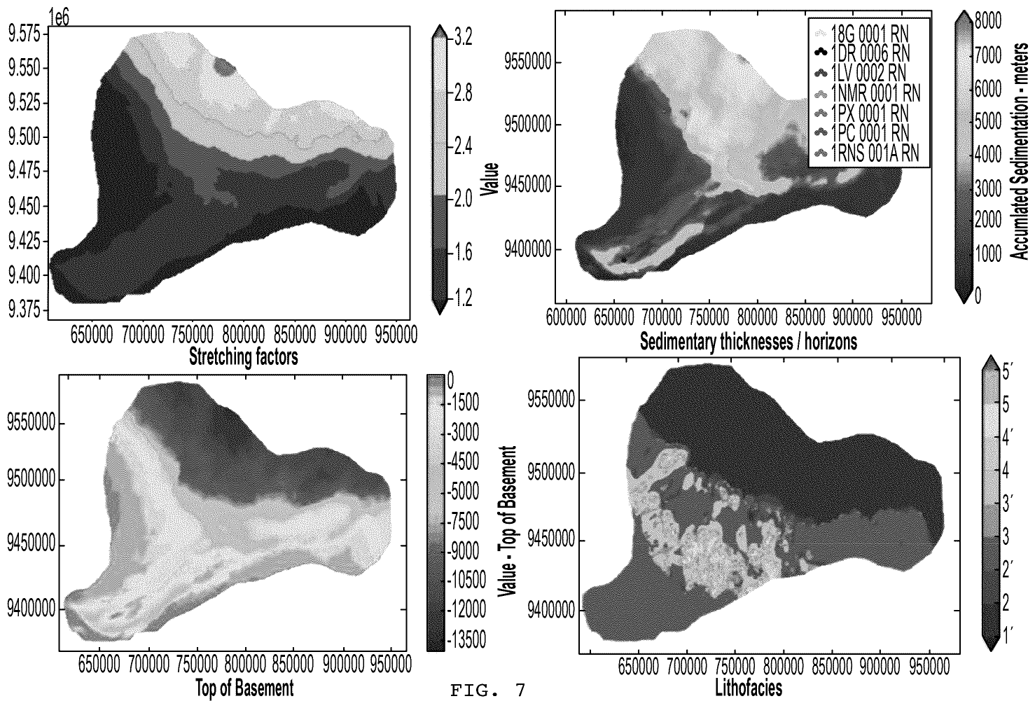

FIG. 10 shows the schematic model for updating the properties in the nodes of the finite element mesh. In FIG. 10, (.)ᵢ denotes the nodal values of the geological properties obtained from the exact shape of the domain at the instant in question.

In general terms, the code receives as input data the spatial distribution (in x, y) of the thicknesses of the sedimentary layers and their corresponding deposition times.

During the simulation, the thickness of each layer z_i is evaluated according to the current instant. Once the current thicknesses have been evaluated, the porosity of each node of the finite element mesh is calculated from Athy's Law and then the thermal properties are evaluated according to the equations for the variation of the thermal properties.

Once the nodal properties have been obtained, the finite element model is defined, interpolating the thermal properties with the same shape functions of the selected element, to generate the mesh.

### Numerical Solution Formulation: Preconditioning Conjugate Gradient (PCG) Method

The numerical solution of the method of the present disclosure uses the Implicit/Explicit method of integration in time, arriving at the following algebraic system of linear equations:

$$( M + Δ {tK}_{e} ) {q}^{t + Δ t} = Δ t ( {q}^{t + Δ t} - {K}_{v} {q}^{t} ) + M {q}^{t} . \qquad ( Equation 10 )$$

where the matrix on the left side is symmetric positive definite.

There are three main characteristics of this system of equations that stand out: symmetry, sparsity and positive definite property.

The symmetry, combined with the positive definite property, causes the system to be generically solved by the Conjugate Gradient Method (CGM). Since it is an iterative method (without changing the structure of the system), it is possible to use sparse data structures to store the linear system. In the implementation of the model described in the present method, a variation of the CGM is used, which is the Preconditioning Conjugate Gradient (PCG) Method, which is a strategy to optimize the traditional method, improving the conditioning of the matrix A of the linear system 10), (equation through a previous multiplication of the system by a matrix that is close to A, but that can be easily inverted.

Therefore, the following equivalent system can be solved:

$${M}^{- 1} A x = {M}^{- 1} b . \qquad ( Equation 11 )$$

The new matrix M⁻¹A has better conditioning than A. The inverse matrix M⁻¹ is obtained by inverting each of the elements of the main diagonal of matrix A and is called the Jacobi technique, used in the numerical simulator implemented to solve the proposed method.

The numerical approximation of the thermal problem is therefore solved using a number of iterations starting from an initial approximation, until convergence is reached based on the error tolerance defined between the current iteration and the previous iteration:

### Initial Approximation:

$${r}_{( 0 )} = b - A {x}_{( 0 )} \qquad ( Equation 12 )$$

$${d}_{( 0 )} = {M}^{- 1} {r}_{( 0 )} \qquad ( Equation 13 )$$

Following iterations:

$${α}_{( i )} = \frac{{r}_{( i )}^{T} {r}_{( i )}}{{d}_{( i )}^{T} {Ad}_{( i )}} \qquad ( Equation 14 )$$

$${x}_{( i + 1 )} = {x}_{( i )} + {α}_{( i )} {d}_{( i )} \qquad ( Equation 15 )$$

$${r}_{( i + 1 )} = {r}_{( i )} - {α}_{( i )} A {d}_{( i )} \qquad ( Equation 16 )$$

$${β}_{( i + 1 )} = \frac{{r}_{( i + 1 )}^{T} {r}_{( i + 1 )}}{{r}_{( i )}^{T} {r}_{( i )}} \qquad ( Equation 17 )$$

$${d}_{( i + 1 )} = {r}_{( i + 1 )} + {β}_{( i + 1 )} {d}_{( i )} . \qquad ( Equation 18 )$$

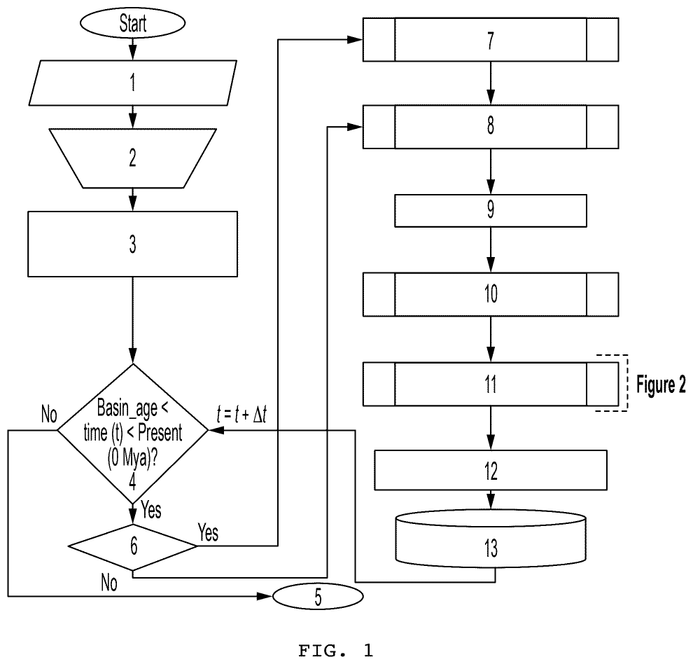

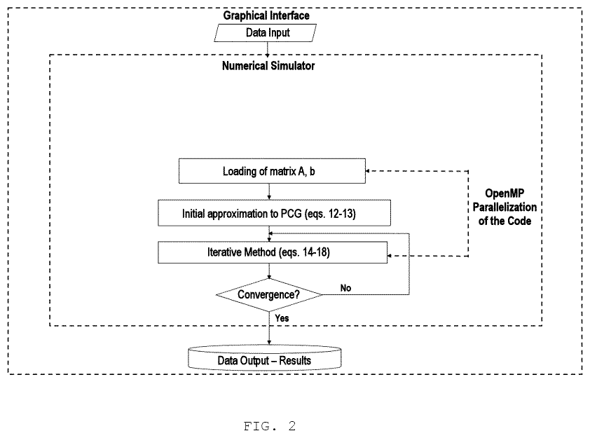

The flowchart in FIG. 2 illustrates the process carried out for the numerical solution of the method of the present disclosure as presented, using the Finite Element approximation.

### Parallelization of the Developed Code to Implement the Method of the Present Disclosure

To reduce the computational time of the simulation process for calculating the blanketing effect, the most critical sections of the code were parallelized. The code was parallelized according to the OpenMP library, which was integrated into the presented methodology.

The parallelism was implemented in two steps, to optimize the steps in which most of the processing time is spent:
1) First, the calculation and assembly of the global matrices of the FEM is parallelized.
2) In the second step, the solution of the linear system of the heat transport problem is parallelized, more precisely the multiplication of the global matrix in sparse format within the iterative process of the PGC.

The parallelization of the assembly and evaluation of the global matrices of the FEM was performed based on a disjoint partitioning of the finite element mesh. This strategy is crucial for code parallelization to be performed efficiently, without race condition problems and without the need to create mutex locks.

Due to the grid structure of the FEM mesh used in the method, the partitioning was performed simply, by simply subdividing the vertical layers into even and odd layers, as shown in FIG. 11, which illustrates the partitioning of the Finite Element Mesh.

### Results of the Method of the Present Disclosure

Using the method of the present disclosure, the following results are obtained, which can be used directly or as input for subsequent steps in the modeling of oil systems, as shown in Table 2 below.

TABLE 2
1D, 2D and 3D results obtained from
the method of the present disclosure

| | |
|---|---|
| Basement temperature | ( ° C.) |
| Basin surface temperature | ( ° C.) |
| Basement heat flow | (mW/m²) |
| Basin surface heat flow | (mW/m²) |
| Sedimentary thickness | (m) |
| Sedimentation rate | (m/Mya.) |
| Effective elastic thickness - Te | (m) |
| Temperatures in each sedimentary layer | ( ° C.) |
| Heat flow in each sedimentary layer | (mW/m²) |
| Heat flow at Moho | (mW/m²) |
| Temperature at Moho | ( ° C.) |
| Isotherm depth maps | (m) |
| Paleobathymetry maps | (m) |
| Depth maps of sedimentary layers at each deposition time | (m) |
| Basement restoration (depth) maps | (m) |

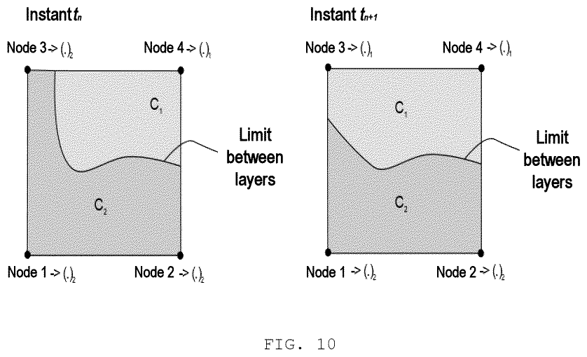

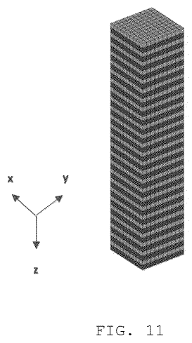

In addition, the standard results are generated in the form of maps of the region under study, as the examples shown in FIG. 12a, FIG. 12b, FIG. 12c and FIG. 12d. FIG. 12a shows heat flow maps for all sedimentary deposition times. FIG. 12b illustrates maps of effective elastic thickness (Te), based on the temperatures. FIG. 12c presents paleogeometries of the basement and the sedimentary layers. FIG. 12d shows a graph with heat flow results: reduction of heat flow at the top and bottom of the basin (Qs and Qb), using the blanketing effect, when compared to the traditional Jarvis&Mckenzie model (Jarvis, G.T., Mckenzie D.P., 1980; D. P.; “Sedimentary Basin Formation with Finite Extension Rates”, Earth and Planetary Science Letters, 48, pp. 42-52.).

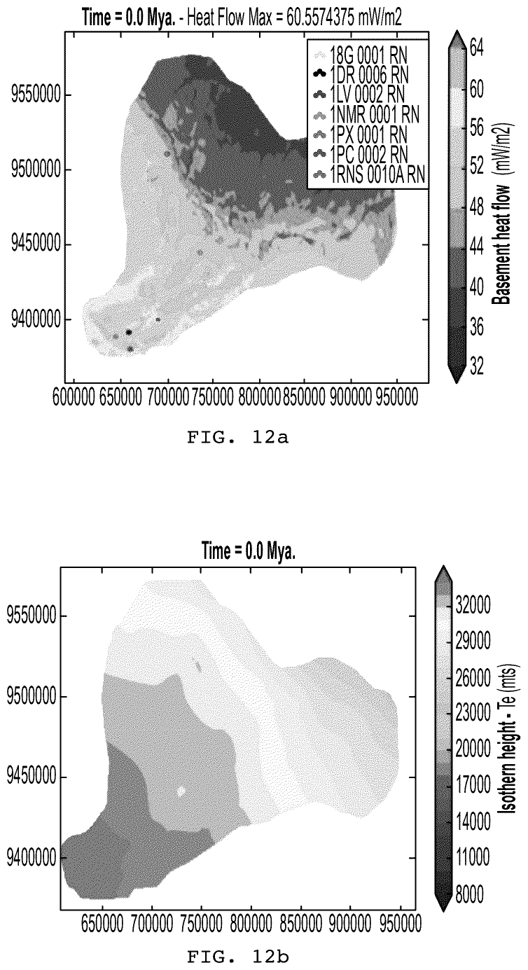

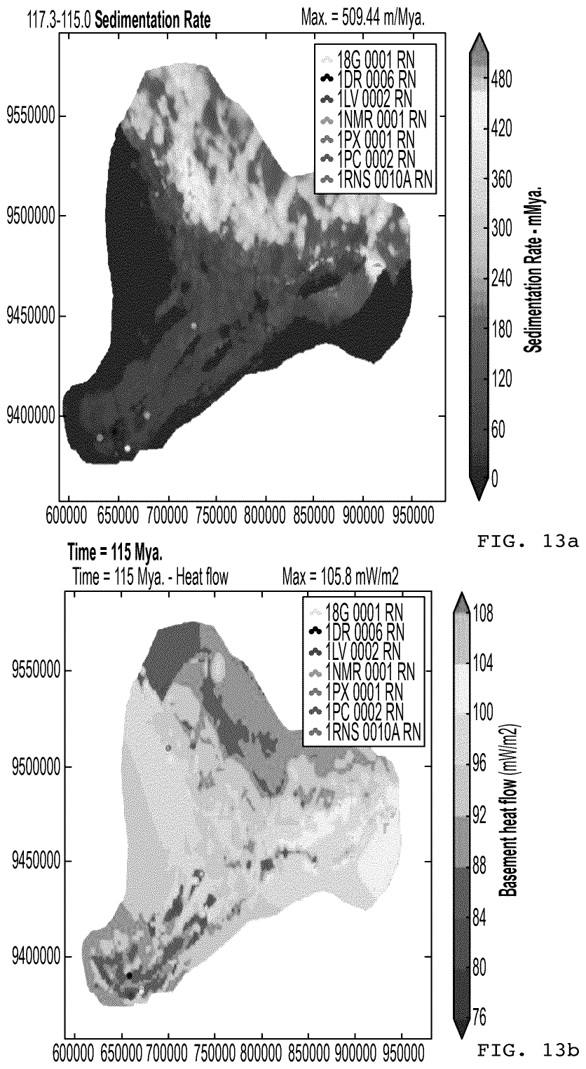

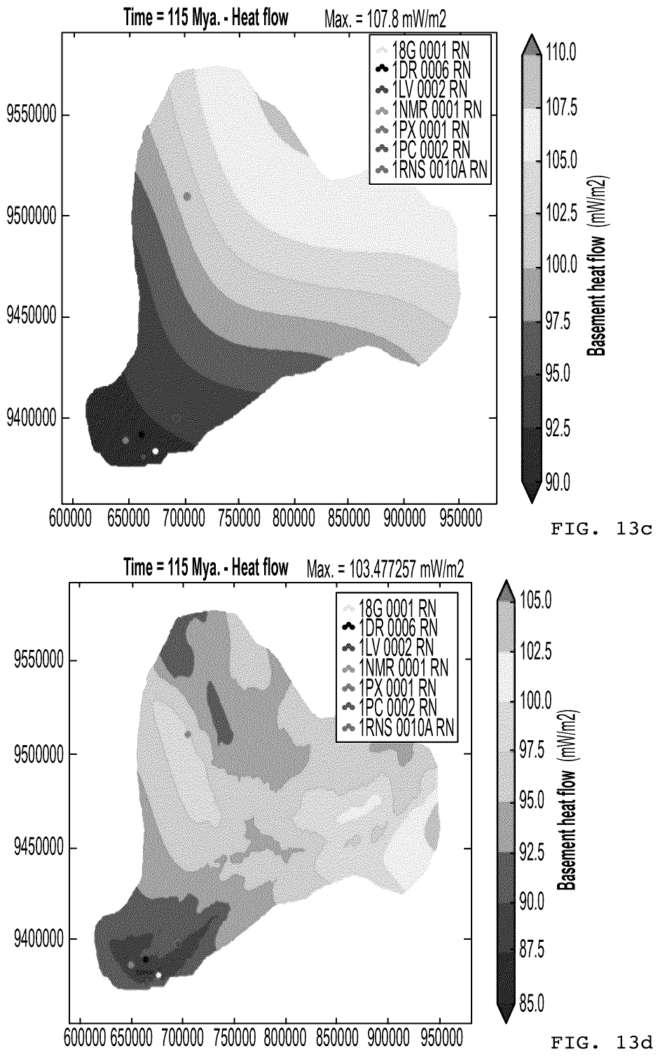

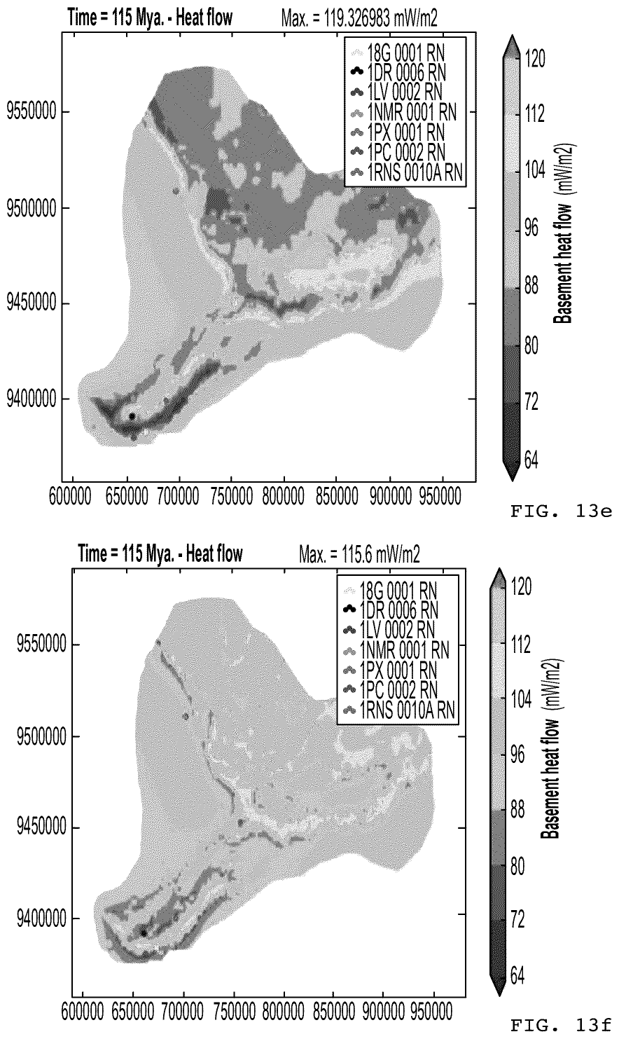

FIG. 13a, FIG. 13b, FIG. 13c, FIG. 13d, FIG. 13e and FIG. 13f show some examples of heat flow results obtained from the implementation of the method of the present disclosure.

The thermal calculation without the blanketing effect results in the very simplified heat flow pattern of FIG. 13c, varying only according to the rifting process defined for the basin and no greater detail is observed in the thermal characteristics of the region under study.

When the blanketing effect is coupled, when the effect of the sedimentation rate and the sedimentary deposition process are considered (FIG. 13a), great detail is observed in the obtained heat flow patterns (FIG. 13b, FIG. 13d, FIG. 13e, FIG. 13f). In these examples, variations in the thermal patterns are observed due to the use of different sediment conductivity values-this is the main characteristic of the blanketing effect.

### Benefits and Application of the Present Disclosure

The present disclosure proposes the integration of the blanketing effect into the quantification of temperature and heat flow in sedimentary basins and is relevant in regions where the sedimentary thicknesses are greater than 3 km, the thermal conductivities are lower than 3.5 W/m/K, and the sedimentation rates are higher than 200m/Mya. In addition, variations in thermophysical properties resulting from salt deposition and compaction contribute to changes in the thermal structure of the region under analysis.

In this context, the application of the proposed method, through the use of a 3D model, which has the capacity to capture geological differences in a wide area, will provide more accurate results with greater resolution and detail on a regional scale.

As an example, according to studies carried out in the proximal portion of the Santos Basin, it is estimated that the heat flow in the basement decreases by 36% when compared to models without the application of the blanketing effect presented herein, since the sedimentation rates are high (approximately 200 m/Mya.) in regions where the pre-salt and post-salt sedimentary thicknesses are approximately 3.5 km and 4 km, respectively. In the distal portion of the Santos Basin, where the thicknesses of the pre-salt and post-salt packages are less than 1.5 km and the salt thickness varies from 3 to 5 km, the blanketing effect is not significant, with a difference of approximately 2% being observed compared to the traditional extended rift model.

In practice, the method described herein has already been applied to analyses of basins such as Santos/Campos, Pelotas, Equatorial Margin, Foz do Amazonas and Namibia, providing excellent results for heat flow and temperatures. Such results, obtained in the form of 3D maps, were compared with data, well with regard to paleotemperatures and vitrinite reflectances, showing very good calibration.

### Used Tools

The method for calculating the blanketing effect in modeling oil systems of the present disclosure, implemented through a computer program, comprises the following tools in a computer program environment to enable the use thereof: a numerical simulator with computational time optimization; and a graphical interface for data input, execution of the numerical simulator and obtaining of the results.

The numerical simulator is responsible for coupling lithospheric events with sedimentary processes (blanketing effect) that were not previously quantified in the basin's thermal calculation. With this, the simulations performed in simulation applications begin to quantify the transient thermal effect related to the deposition and compaction of cold sediments, known as the blanketing effect, integrating the same with the other processes existing in the model, such as the evolution of the geothermal gradient, the lithospheric stretching (rifting) and the radiogenic heat present in the upper portion of the crust.

A graphical interface can be designed especially to enable the use of the method of the present disclosure, being easy and intuitive to use. For example, a graphical interface can be developed to apply the algorithms that define the proposed sequence of processes, enabling the input of a large amount of data and the provision of results with a high level of detail on a regional scale, for the areas under study.

The method for calculating the blanketing effect in the modeling of oil systems of the present disclosure leads to improved results, with the coupling of lithospheric events with sedimentary processes (blanketing), which were not previously quantified in the thermal calculation of the basin. In other words, the simulations performed in simulation programs began to quantify the transient thermal effect related to the deposition and compaction of cold sediments, known as the blanketing effect, integrating the same with the other processes existing in the model, such as the evolution of the geothermal gradient, the lithospheric stretching (rifting) and the radiogenic heat present in the upper portion of the crust.

This process, called the blanketing effect, came to fill one of the important gaps that were missing for the refinement of the thermal calculation of the sedimentary basins.

### Graphical Interface Developed in C++/QT

The numerical simulator and the graphical interface can be developed in the C++and QT languages, respectively, in addition to the use of public domain libraries, such as OpenMP, to optimize computational time, among others.

To start the process, it is necessary to select the type of simulation (“thermal” or “3D backstripping +thermal”) in the graphical interface.

The graphical interface developed in C++/QT enables the application of the method of the present disclosure in real cases of basins and the presentation of results in the form of heat flow and temperature maps. The graphical interface is designed and implemented especially for the implementation of the method of the present disclosure and enables the development of thermomechanical models for basin simulation in an intuitive manner, presenting results with a high level of detail in the form of text files, which can be imported into visualization tools.

Complementarily, the present disclosure

relates to a computer-readable storage media, which comprises, stored therein, a set of computer-readable instructions, wherein, when the set of computer-readable instructions is executed by one or more processors, the one or more processors implement the method of the present disclosure, as described above.

Particularly, the computer-readable storage media may be a memory, wherein the memory may be a non-volatile type, such as a hard disk drive (HDD) or a solid-state drive (SSD), or it may be a volatile memory, such as a random-access memory (RAM). Furthermore, the readable storage media may be any other medium or media that can transport or store or record the expected program code in the form of an instruction or a data structure or a set of instructions, and can be accessed by one or more computers or one or more processors, but is not limited to the same. The readable storage media may alternatively be a circuit or any other device or medium that can implement a storage or transport or recording function, such as a signal or a carrier.

Specifically, the set of computer-readable instructions represents the algorithm or computer program code or a data structure that performs the method of the present disclosure as described above.

The processor may be a general-purpose processor, which may be a microprocessor or any conventional processor or the like.

Those skilled in the art will appreciate the knowledge presented herein and will be able to reproduce the disclosure in the presented embodiments and in other variants, encompassed by the scope of the appended claims.

1. A method for determine blanketing effect in modeling oil systems, the method comprising:
obtaining input lithospheric and sedimentary data;
discretizing the model differently in the sedimentary domain and in the lithospheric domain;
starting determination of the blanketing effect;
checking whether the deposition time corresponding to each sedimentary layer is greater than the present time and whether the age of the basin is greater than the deposition time corresponding to each sedimentary layer,
refraining from performing the method for a selected period of time;
checking whether the deposition time corresponding to each sedimentary layer is less than or equal to the present time and whether the age of the basin is less than or equal to the deposition time corresponding to each sedimentary layer and checking whether it is in the rifting period, and wherein:
if it is in the rifting period, determining the rifting,
if it is not in the rifting period, or if it is in sequence to the determining of the rifting, determining sedimentation,
determining advective vertical displacement velocity due to rifting for each XY coordinate;
determining fluid flow,
using finite elements to perform calculation at each instant of time,
performing the sum of the thermal effect of the lithospheric and sedimentary domains at each time step.

2. The method according to claim 1, wherein the lithospheric and sedimentary data comprise at least one of:
dimensions of the area,
thermophysical parameters including one or more of: conductivity of the crust, specific mass of the crust, specific heat of the crust, radiogenic heat of the crust, conductivity of the lithospheric mantle, specific mass of the lithospheric mantle, specific heat of the lithospheric mantle, radiogenic heat of the lithospheric mantle, specific mass of water, conductivity of water, specific heat of water, specific mass of the asthenosphere, coefficient of elasticity, Poisson's ratio, coefficient of thermal expansion, acceleration of gravity, or isotherm temperature for Te,
boundary conditions in the lithosphere, including one or more of surface temperature or base temperature, lithospheric data, corresponding to the number of layers and thermophysical properties of the layer, and comprising at least one of: thickness, specific mass, specific heat, conductivity, or radiogenic heat, and maps of horizons and lithofacies for each sedimentary layer, and wherein the t salt and igneous maps are optionally selected depending on the region of interest,
values for the discretization of the numerical model, age of the basin,
time and period of the rift, or
values or maps of the stretching factors of the lithosphere or crust and mantle.

3. The method according to claim 1, wherein if it is in the rifting period, determining the rifting comprises calculating the transient heat due to lithospheric thinning, which causes variations in the heat flow, from the advective thermal model:
$$( ρ c ) ( θ ) \frac{\partial T}{\partial t} + ( 1 - θ ) {( ρ c )}_{s} {T}_{, i} {v}_{i}^{s} = λ ( θ ) {( {T}_{, i} )}_{, i} + ( ρ r ) ( θ ) ∀ x ∈ Ω$$
where:
v^{s} denotes the velocity of the solid particles;
θ is the porosity;
ρ is the specific mass;
c is the decay constant;
and λ is the conductivity;
calculating the crust value δ and the mantle value β within the rift, according to:
$$β = {e}^{G Δ t}$$
calculating thicknesses and horizons of the sediment layers as a function of the crust value δ and the mantle value β;
quantifying the radiogenic heat in the upper portion of the crust.

4. The method according to claim 1, wherein the determining sedimentation includes calculating the blanketing effect due to the deposition of sediments, through an advective model, including:
decompacting sediment layers,
stacking and compacting sediment layers until the corresponding deposition time and according to the thermal parameters recalculated in depth,
recalculating basement depth, and
calculating the radiogenic heat in the sedimentary portion.

5. The method according to claim 1, wherein the determining advective vertical displacement velocity due to rifting, for each xy coordinate, includes calculating through the formulation vbulk=G*(h−z) for each vertical coordinate z, where vbulk=average velocity of the uplift of the asthenosphere due to rifting, varying linearly in z; G=magnitude of the vertical velocity gradient along the lithosphere h, indicating how much the fluid velocity displaces vertically, along the thickness defined as “h” in the formulation; h=depth limit of the lithosphere; further including adding the advective velocities to the sedimentation velocity, wherein the greater the compaction, the slower the uplift due to rifting.

6. The method according to claim 1, wherein the determining fluid flow includes defining thermal properties at the nodes of the 3D numerical grid, comprising at least one of conductivity, radiogenic heat, specific mass*specific heat of the solid part, specific mass*specific heat of the fluid part.

7. The method according to claim 1, further comprising generating outputs for the corresponding deposition time, including generating maps, sections and well profiles with the thermal and structural information of the sedimentary basin.

8. A computer-readable storage media, comprising, stored therein, a set of computer-readable instructions, which, when executed by a computer, executes the method as defined in any one of claim 7.
